(19) United States
(12) Patent Application Publication
(10) Pub. No.: US 2006/0009059 A1
(43) Pub. Date: Jan. 12, 2006

(54) Removable portable ground fault interrupt connector

(76) Inventor: Jeffory J. Gentle, Phoenix, AZ (US)

Correspondence Address: Starkweather & Associates, 9035 S 1300 E, Suite 200, Sandy, UT, 84094, US

(21) Appl. No.: 10/889,323

(22) Filed: Jul. 12, 2004

(51) Int. Cl. H01R 13/53

(52) U.S. Cl. 439/181

(57) ABSTRACT

An electrical connection connector device, comprising a housing portion designed to position a removable GFI, which is designed to securely connect to a first and second electrical connector. The housing comprises a top transparent section and a bottom section which may be coupled together. The GFI device may be connected to the first and second electrical connectors within the housing, or the GFI may be removed and connected to the first and second electrical connectors without the housing. Restraining portions within the housing securely position the first and second electrical connectors within the housing and inhibit moisture from seeping past the electrical cords into the housing. The restraining portions may comprise a flexible material.

### BACKGROUND OF THE INVENTION

1. The Field of the Invention

The present invention relates to a removable portable ground fault interrupt (GFI) connector. Specifically, the present invention relates to a removable electrical cord connector with a GFI feature with a moisture resistant housing.

2. The Relevant Art

For many years our society has had a sharp increase in the use of portable electrical tools. Consequently the use of electrical cords has also sharply increased. The typical home owner, for example, may use an electrical lawn mower, an electrical weed cutter or an electrical leaf blower. A typical construction site uses numerous electric saws, lights, drills, and nail guns.

However, this incessant need for more and more electrical tools has not come without a price. Every year thousands of individuals have been injured or died as a result of electrocution from using these same tools. One of the most common causes of this danger is that most users simply do not have electrical cords that extend or reach as far as is necessary. Therefore, as a simple fix to this situation, the user simply connects two cords together. Similarly, poor maintenance and improper use of electrical cords contributes to the danger.

In and by itself, the two cord connection system is not a problem. However, most lawns or work sites are often besieged by moist environments. Specifically, a work site can have standing puddles, a lawn may have just been watered by sprinkler systems, or morning dew may be lying on the grass.

One profession in particular, has a very high occurrence of standing water that is extremely dangerous for electrical cords. Firemen, in their every day professional operation, use many electrical tools. For example, electrical fans are needed to move air after fires are extinguished; electrical saws are needed to cut access holes, for example, before, during and after a fire. When these electrical cords are employed, the connection points of these cords often are located near if not in standing water. As is often the case, a fireman will contact the electrified water and experience an unpleasant sensation, at the least, and a deadly one, at most.

For years ground fault interrupters (“GFI's”) have been used to curtail these dangers. GFI's are designed to protect from electrical shock by interrupting a circuit when there is a difference in the currents in the “hot” and neutral wires. Such a difference indicates that an abnormal diversion of current from the “hot” wire is occurring. Such a current might flow in the ground wire, such as a leakage current from a motor or from capacitors. More importantly, that current diversion may occur because a person has come into contact with the “hot” wire and is being shocked. When a circuit is functioning normally, all the return current from an appliance flows through the neutral wire, so the presence of a difference between “hot” and neutral currents represents a malfunction which in some circumstances could produce a dangerous or even lethal shock hazard.

GFI's are required by the electrical code for receptacles in bathrooms, some kitchen receptacles, some outside receptacles, and receptacles near swimming pools. The horror story scenarios which led to these code requirements are things like dropping a hair dryer or a portable radio into a bathtub with a person, causing electrocution. A typical circuit breaker interrupts the circuit at 20 amperes, but it takes only about 100 milliamperes to electrocute a person in such a scenario. The GFI is designed to detect currents of a few milliamperes and trip a breaker at the receptacle or at the breaker panel to remove the shock hazard. Unfortunately, not all receptacles include the GFI and not all goods, such as appliances, tools, and computers, include a built in GFI.

Accordingly, a need exists for a removable portable connector device that allows for the removal of the GFI to use with unprotected goods, goods that require connections that do not fit within a GFI housing, and the ability to connect two or more electrical cords in moist environments, to eliminate, or at least greatly decrease, the risk of electrocution to those persons using potentially dangerous goods.

### SUMMARY OF THE INVENTION

The various elements of the present invention have been developed in response to the present state of the art, and in particular, in response to the problems and needs in the art that have not yet been fully solved by currently available GFI devices. Accordingly, the present invention provides a device for a removable portable GFI connector. More particularly, there is an electrical cord connector that has both a removable GFI feature and a moisture resistant housing.

The device provides for an electrical connection connector device, comprising a housing designed to position a removable GFI, which is designed to securely connect to a first and second electrical cord. The housing comprises a top transparent portion and a bottom portion which may be coupled together. The GFI device may be connected to the first and second electrical cords within the housing, or the GFI may be removed and connected to the first and second electrical cords without the housing. Restraining portions within the housing securely position the first and second electrical cords within the housing and inhibit moisture from seeping past the electrical cords into the housing. The restraining portions may comprise a flexible material.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

Additional features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view illustrating a removable portable ground fault interrupt connector in accordance with one embodiment of the present invention;

FIG. 2 is an exploded view of a removable portable ground fault interrupt connector in accordance with one embodiment of the present invention; and

FIG. 3 is a cross-sectional side view of a removable portable ground fault interrupt connector in accordance with one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

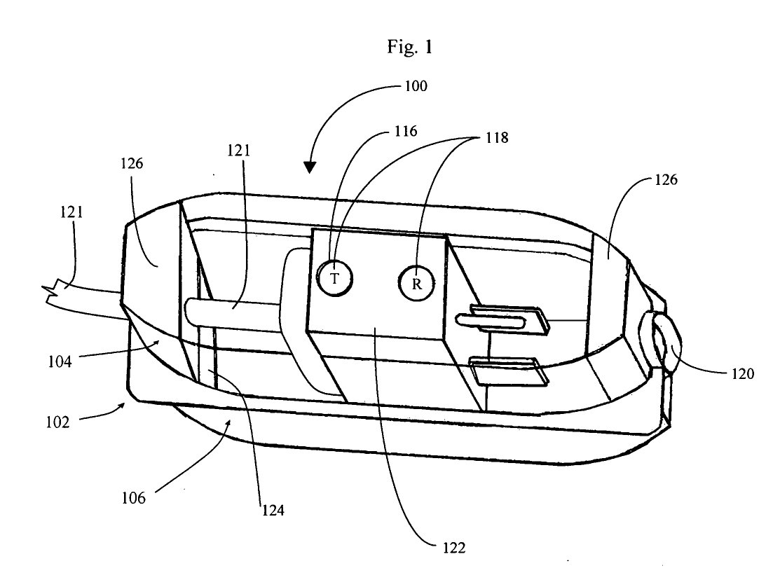

FIG. 1 illustrates a perspective view of one embodiment of a removable portable ground fault interrupt connector (“GFI connector”) 100. In this embodiment, the GFI connector 100 comprises a plastic housing 102 having a first housing section 104, illustrated as a top portion, and a second housing section 106, illustrated as a bottom portion. One embodiment the first housing section 104 is transparent or translucent to allow some amount of viewing into the housing 102.

It is noted that the plastic housing 102 may be made of STAREX, which can be purchased at H. Muehlstein & C., 800 Connecticut Ave., Norwalk, Conn. 06854 U.S.A., Phone: 1-800-257-3746 and which is discussed in U.S. Pat. No. 6,592,393, which is incorporated herein by reference for its teachings. This material emits a fire suppressant or extinguishing gas a when exposed to a spark or fire conditions. A skilled artisan will know that this material works when it is exposed to fire sufficient to begin melting, whereby the material will then exhibit the anti-fire characteristics. Although, it is noted and even contemplated to make the housing 102 out of any known material that has fire and smoke resistant characteristics.

In one embodiment, the first housing section 104 may include a set of holes 116 located on the top section 104 that allows control buttons 118 on the surface of the GFI 122 to protrude therefrom. In another embodiment, instead of using the holes 116, a flexible material is placed on the housing section 104 above the control buttons 118. The flexible material is capable of being pressed to contact the control buttons 118. The control buttons 118 typically may include a test “T” and a reset “R” button, but the invention is not limited to these in particular. The user may press the “T” button to check to see if the GFI connector is functioning correctly. The user may press the “R” button to reset the GFI connector if the GFI connector has tripped due to a fault or error.

The GFI connector 100 includes a receiving hole 120 at each end for receiving an electrical cord 121 therethrough, and to allow the cord 121 to connect to a ground fault interrupter (“GFI”) 122. Restrainers 124 and 126 are located at each end of the GFI connector 100 and hold the electrical cords 121 within the GFI connector 100. The restrainers 124 and 126 prevent the electrical cords 121 from disconnecting from the GFI 122 and inhibit moisture from entering into the GFI connector 100.

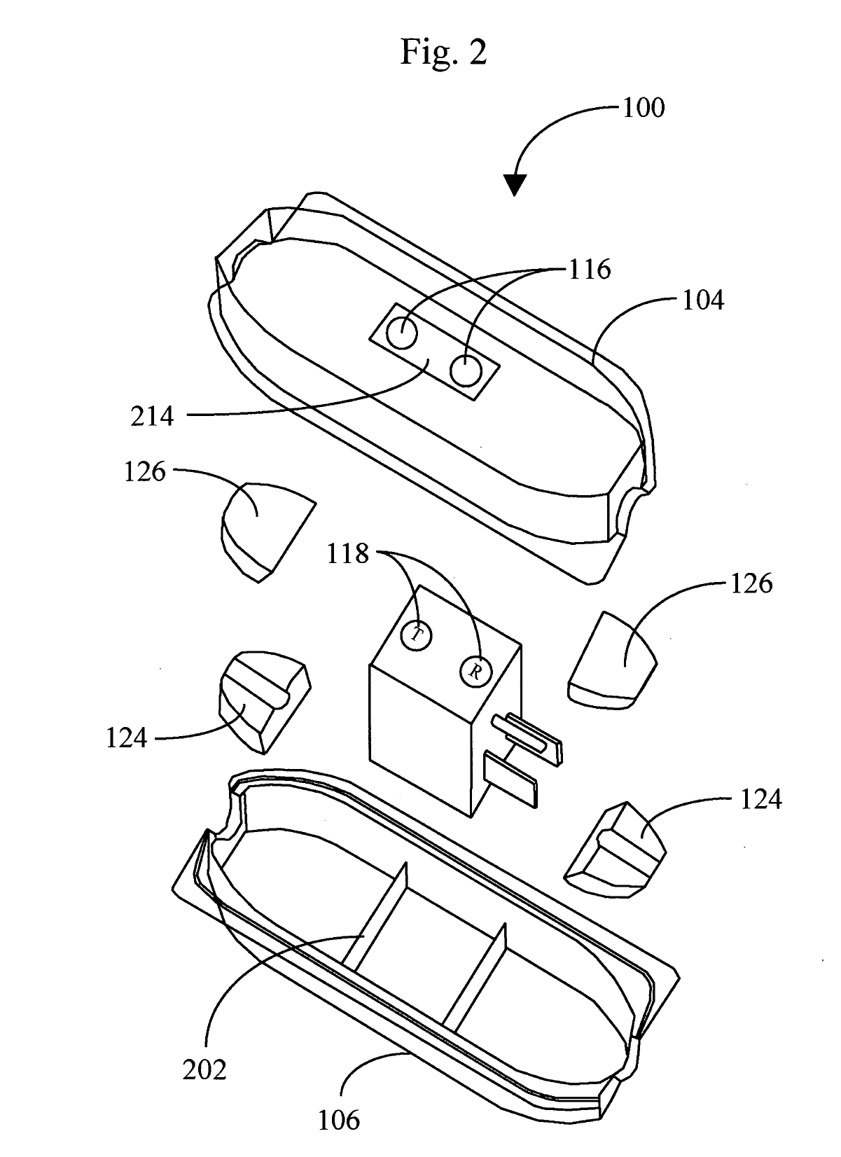

FIG. 2 illustrates an exploded view of the GFI connector 100 in accordance with another embodiment of the present invention. The first and second housing sections 104 and 106 are configured to house the GFI 122. The second housing section 106 includes positioning members 202 for receiving and positioning the GFI 122 in a central location within the GFI connector 100. In this embodiment, the GFI 122 is configured to be removable from between the positioning members 202. An advantage of a removable GFI 122 is to increase the universal use of the GFI 122. Specifically, many electrical devices do not have GFI's 122 built into the system. Similarly, many electrical devices are not equipped to connect to a GFI 122 enclosed in a housing. Additionally, in some applications, moisture and stress relief are not a concern when using electrical devices, and therefore, a GFI housing is not absolutely necessary. Accordingly, it is advantageous to have a removable GFI 122.

A light indicator may be designed to show that the GFI 122 is in one of several states. Specifically, the GFI 122 may include a green light, or LED, within the clear or translucent housing 102, or GFI 122, to indicate that the GFI 122 device is “on” and functioning correctly and that electricity is flowing evenly across the GFI 122. In contrast, a red light, or red LED, would indicate that the GFI 122 is “off” and that an error or fault has occurred, that electricity has flowed unevenly across the GFI 122, or that the test button has been activated and electricity is prevented from flowing through the GFI 122 until the “R” reset button has been activated.

The restrainers 124 and 126 include grooves 206 formed along each restrainer 124 and 126 that form a canal for holding the electrical cords 121 when the top section 104 and the bottom section 106 unite. A slanted section 208 is configured to accommodate a plug located at the end of the electrical cords 121 and to hold the plug against the GFI 122. In a preferred embodiment, the restrainers 124 and 126 are comprised of a soft flexible type material and may contain fire retardant and water repellant properties. One embodiment may include a GFI restrainer 214, which encircles the control buttons 118 at the top surface of the GFI 122, for securing the GFI 122 inside the housing 102 and for preventing moisture from passing through the set of holes 116 to the inside of the housing 102.

The restrainers 124 and 126 fit tightly against the inside top and bottom surfaces of the GFI connector 100. When the top housing section 104 is closed the restrainers 124 and 126 unite to form a tight fit around the electrical cords 121. The restrainers 124 and 126, therefore, prevent moisture from gaining easy access to the interior of housing 102, as well as secure the electrical cords 121 within the housing 102.

In a preferred embodiment, the restrainers 124 and 126 may have air cells made to contain an inert gas, such as halon, argon, neon or any of the other periodic table inert gases. A skilled artisan will easily realize that any other non-flammable gas or a gas that actually inhibits fire or smoke, such as carbon dioxide or nitrogen would also work. Thus, if an electrical cord 121 begins to short or spark, the cells in the foam break open and release the fire and/or smoke suppressant gas, thus suppressing the fire conditions.

The top section 104 has several elements that correspond to elements located in the bottom section 106. Specifically, the first housing section 104 may include a tongue 108, which encircles the first housing section 104 on a lip 110. The second housing section 106 may include a groove 112 on a second lip 114 for receiving the tongue 108. In this embodiment, both the first housing section 104 and the second housing section 106 are comprised of plastic, which includes a deforming property to allow the tongue 108 to pass into the groove 112. Jointly, the tongue and groove form a water resistant housing when the tongue 108 is pressed into the groove 112.

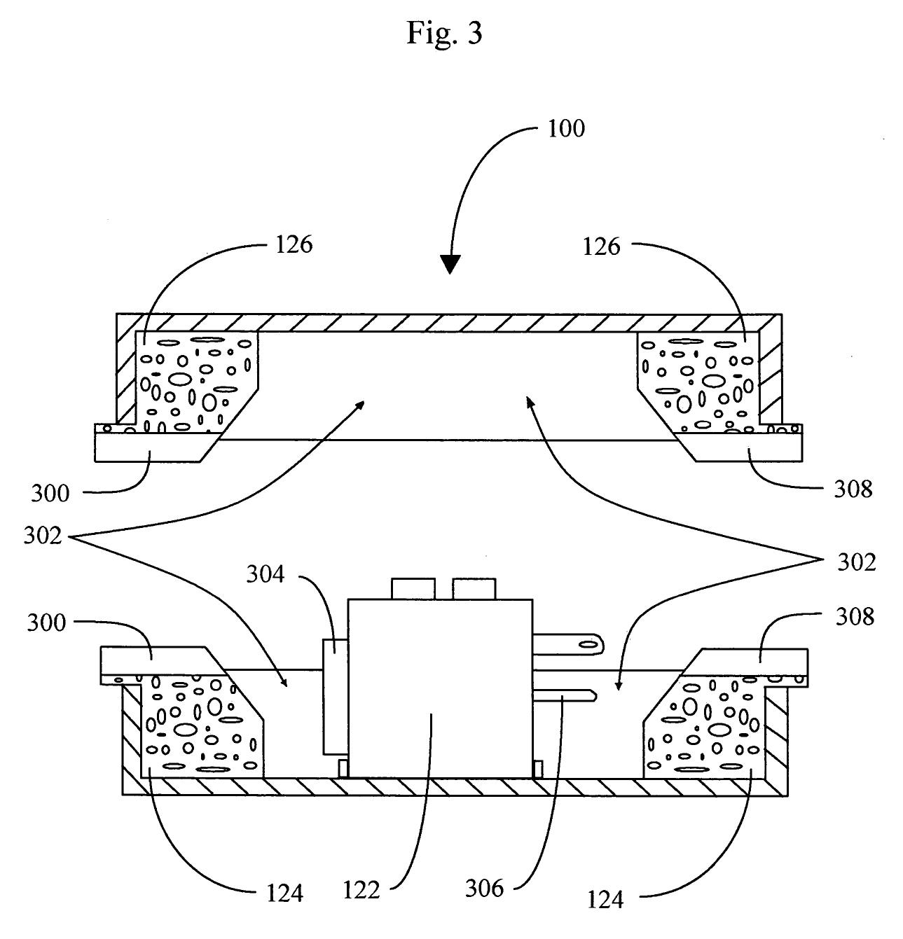

FIG. 3 illustrates a side cross-sectional view of one embodiment of the GFI connector 100. The GFI 122 is configured to receive electrical cords 121 through the restrainers 124 and 126, along a groove 300 and into a cavity 302 to connect a male connector to a female 304 connection of the GFI 122 or to connect a female plug to a male portion 306 of the GFI 122. The top section 104 shuts over the electrical cords 121 to form a tight water resistant seal to prevent moisture from entering the cavity 302 and ultimately to prevent moisture from contacting the electrical male 306 and female plugs 304, thus preventing electrocution of workers using this device in water laden environments.

The GFI 122 may be removed from the GFI connector 100 to be plugged directly into an electrical connector that would normally not fit within the housing, i.e. a wall socket would not fit into the housing 102. Consequently, the GFI 122 would lose the advantage of being water resistant; however, the GFI 122 would gain the advantage of versatility. Specifically, the GFI 122 may be used in water laden environments when installed within the housing 102, and it may be removed to be used with any type of electrical device when moisture may not be considered a significant threat.

It is noted that there are innumerable variations that could be undertaken in the design of the described invention once a skilled artisan has read the attached specification. For example, the restrainers 124 and 126 are shaped to fit electrical cords 121, and the restrainers 124 and 126 include slanted sections 208 for fitting electrical plugs. However, a skilled artisan would envision many types of shapes that may be carved into the restrainers 124 and 126 to accommodate the electrical cords 121 and the plugs. For example, a form fitting cavity 302 may be used. Additionally, the restrainers 124 and 126 may extend all the way into the housing 102, thus eliminating most of the cavity 302 and only making enough room for the plugs.

Another design choice is the inclusion of control buttons 118 inside the housing 102. Specifically, the control buttons 118 may not be actuatable from the outside of the housing 102. It would be necessary to open the housing 102 to reset or test the GFI 122. Additionally, although two control buttons 118 are illustrated, there are any combination of control buttons 118 that may exist. For example, the test “T” button may be eliminated and there may only be the reset “R” button. More buttons may also exist as the need dictates.

A skilled artisan will realize that although only an elementary illustration has been made for securing the top and bottom sections 104 and 106 of the housing 102, there are, in fact, a plethora of design choices available. The main goal of any connection means utilized will be the retardation of moisture from gaining access to the interior of the housing 102 to prevent electrical shortages. For example, foam, rubber or gasket type material may be used around the edges of the housing 102, or locking type designs may be utilized. There may be hinges, snaps, clasps, sliding portions etc.

Although the first and second section 104 and 106 are illustrated as having separate restrainers 124 and 126, it is contemplated to make the housing 102 as one continuous unit. Specifically, the entire housing 102 may be made of a pliable material that would seal against the electrical cords when the first and second sections 104 and 106 are closed together.

It is noted that no device can be made to both open and close and to have passageways from the exterior to the interior and have a completely moisture proof design without encountering significant costs. Therefore, the present invention incorporates a GFI 22, which deactivates the electrical flow when water is sufficiently accumulated to cause potential electrocution of persons coming in contact with the exposed water.

It is noted that the restrainers 124 and 126 do not have to be attached to the housing 102, they could be friction fit into the housing 102, i.e. wedged into place. The restrainers 124 and 126 may also be glued down to get a tight seal around the electrical cords 121.

The restrainers 124 and 126 may appear level to the edges of the first and second sections 104 and 106 or as forming a canal with the same diameter as the openings 120 when the restrainers 124 and 126 unite, however, skilled artisans would realize that having a smaller diameter on the restrainers 124 and 126 would be beneficial to further prevent moisture seepage along the passageway used by the electrical cord 121 to have access to the GFI 122. Thus, closing of the top and bottom sections 104 and 106 would cause the restrainers 124 and 126 to squeeze around the electrical cords 121 to form a tighter fit.

Although the specification discusses the use of lights within the GFI 122 to indicate the status of the GFI 122, it is envisioned that the GFI connector may include other locations for the lights. The lights may be mounted on the exterior of the housing or they may be placed to be viewable through the transparent first housing section 104 and placed next to the control buttons 118.

Additionally, the specification discusses the use of a transparent first housing section 104. It is envisioned that the entire housing 102 may be transparent or that just a portion of the housing 102 be transparent.

Numerous other modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications are contemplated.

What is claimed is:

1. An electrical cord connector device, comprising:
a housing designed to hold a first and second electrical cord therein;
a GFI device removably coupled to the housing, configured to connect to the first and second electrical cords; and
a restraining portion, located within the housing, designed to securely restrain the first and second electrical cords within the housing and to inhibit moisture from seeping into the housing.

2. The electrical cord connector device according to claim 1, wherein the GFI device further comprises a status indicator.

3. The electrical cord connector device according to claim 2, wherein the status indicator includes a green light for indicating that the GFI is functioning properly and a red light for indicating that the GFI is not functioning properly.

4. The electrical cord connector device according to claim 2, wherein the status indicator is a sound producing device for indicating when the GFI is not functioning properly.

5. The electrical cord connector device according to claim 1, wherein the restraining portion comprises a flexible material.

6. The electrical cord connector device according to claim 1, wherein the housing comprises a first and second section.

7. The electrical cord connector device according to claim 1, wherein the GFI device includes a male and female coupling capable of being coupled to a corresponding male and female end of an electrical cord.

8. The electrical cord connector device according to claim 6, wherein the first and second sections include a coupling means for connecting the first section to the second section.

9. The electrical cord connector device according to claim 8, wherein the coupling means is a tongue and groove.

10. The electrical cord connector device according to claim 8, wherein the coupling means comprises a hinge and clamping device.

11. An electrical cord connector device, comprising:
a housing portion having a transparent section, the housing designed to hold a first and second electrical connector therein;
a GFI device removably coupled to the housing, the GFI device including a status indicator, and the GFI device designed to connect to the first and second electrical connectors;
a restraining portion, located within the housing, designed to securely restrain the first and second electrical connectors within the housing and to inhibit moisture from seeping into the housing.

12. The electrical cord connector device according to claim 11, wherein the status indicator includes a green light for indicating that the GFI is functioning properly and a red light for indicating that the GFI is not functioning properly.

13. The electrical cord connector device according to claim 11, wherein the status indicator is a sound producing device for indicating when the GFI is not functioning properly.

14. The electrical cord connector device according to claim 11, wherein the restraining portion comprises a flexible material.

15. The electrical cord connector device according to claim 11, wherein the housing comprises a first and second section.

16. The electrical cord connector device according to claim 11, wherein the GFI device includes a male and female coupling capable of being coupled to a corresponding male and female end of an electrical connector.

17. The electrical cord connector device according to claim 15, wherein the first and second sections include a coupling means for connecting the first section to the second section.

18. The electrical cord connector device according to claim 17, wherein the coupling means is a tongue and groove.

19. The electrical cord connector device according to claim 17, wherein the coupling means comprises a hinge and clamping device.

20. An electrical cord connector device, comprising:
a housing designed to hold a first and second electrical cord therein;
a GFI device removably coupled to the housing, configured to connect to the first and second electrical cords; and
a restraining portion, coupled to the housing, designed to securely restrain the first and second electrical cords within the housing and to inhibit moisture from seeping into the housing.
